(19) United States
(12) Patent Application Publication
(10) Pub. No.: US 2015/0152286 A1
(43) Pub. Date: Jun. 4, 2015

(54) THERMALLY CONDUCTIVE NANOCOMPOSITE COATING COMPOSITIONS

(71) Applicant: ENERGYGUARD ATLANTIC, LLC, New York, NY (US)

(72) Inventors: Patrick Michael Rathje, New York, NY (US); Don Ray Sharp, New York, NY (US)

(21) Appl. No.: 14/616,176

(22) Filed: Feb. 6, 2015

Related U.S. Application Data
(63) Continuation of application No. 13/425,894, filed on Mar. 21, 2012, now abandoned.

(51) Int. Cl. C09D 175/04

(52) U.S. Cl. CPC C09D 175/04

(57) ABSTRACT

Thermally conductive nanocomposite coating compositions comprising an adhesive system with embedded nanoparticles. The adhesive system comprising a mixture of 40-60% urethane prepolymer, and 40-60% polymeric methylene diphenyl diisocyanate. The nanocomposite composition providing an elastomeric coating which is resistant to corrosion, water, oxygen, acids and salts, and which provides thermal conductivity.

### PRIORITY/CROSS-REFERENCE TO RELATED APPLICATIONS

This application claims the benefit of U.S. Provisional Application No. 61/454,714, filed 21 Mar. 2011, the disclosure of which is incorporated by reference.

This application claims the benefit of U.S. Provisional Application No. 61/454,752, filed 21 Mar. 2011, the disclosure of which is incorporated by reference.

### TECHNICAL FIELD

The disclosure generally relates to the field of substrate coatings. Particular embodiments relate to thermally conductive nanocomposite coating compositions.

### BACKGROUND

Polymers, such as urethane-based polymers and polyurethane-based polymers, are frequently used as coatings. Such coatings providing a hermetic seal to the substrate coated. The benefit to utilizing such a urethane-based polymer or polyurethane-based polymer coating is that it provides an elastomeric coating which is resistant to corrosion, water, oxygen, acids and salts. However, such polymer coatings typically exhibit low thermal conductivity, poor thermal diffusivity, and can be prone to microbial growth.

### SUMMARY OF THE DISCLOSURE

Several exemplary thermally conductive nanocomposite coating compositions are described herein.

An exemplary thermally conductive coating composition comprises a urethane prepolymer, a polymeric methylene diphenyl diisocyanate, at least one thinning agent, and nanoparticles. This exemplary thermal conductive coating composition having a number of alternative compositions. In an alternative composition, the nanoparticles comprise fullerenes. In another alternative composition, the nanoparticles comprise carbon nanotubes. In another alternative composition, the nanoparticles comprise metal nanospheres. In another alternative composition, the thinning agent comprises at least one organic solvent. In another alternative composition, the thinning agent comprises xylene. In another alternative composition, the thinning agent comprises acetone. In another alternative composition, the thinning agent comprises D-limonene. In another alternative composition, the thinning agent comprises toluene. In another alternative composition, the composition further comprises an additive. In another alternative composition, the composition comprises at least one pigment. In another alternative composition, the composition comprises at least one chemical surfactant.

In another alternative composition, the composition comprises 85% urethane, 7% D-limonene, 5% toluene, 2% fullerene, and 1% chemical surfactant. In another alternative composition, the composition comprises 80% urethane, 9% xylene, 8% acetone, 2% fullerene and 1% chemical surfactant. In another alternative composition, the composition comprises 80% urethane, 17% D-limonene, 2% fullerene and 1% chemical surfactant. In another alternative composition, the composition comprises 75% urethane, 12.5% D-limonene, 9.25% acetone, 0.75% fullerene, and 2.5% pigment. In another alternative composition, the composition comprises 78% urethane, 15% xylene, 3.5% acetone, and 3.5% pigment.

In another alternative composition, the composition comprises 40-60% urethane prepolymer and 40-60% polymeric methylene diphenyl diisocyanate; 9% xylene; 8% acetone; 2% fullerene; and 1% chemical surfactant. In another alternative composition, the composition comprises 75% of an adhesive system comprising 40-60% urethane prepolymer and 40-60% polymeric methylene diphenyl diisocyanate, 12.5% D-limonene, 9.5-10.5% acetone, and 0.75-2.0% fullerene. In another alternative composition, the composition comprises 75% of an adhesive system comprising 40-60% urethane prepolymer and 40-60% polymeric methylene diphenyl diisocyanate, 12.5% D-limonene, 9.5-10.5% acetone, 0.75-2.0% fullerene, and about 0-2.5% pigment. In another alternative composition, the composition comprises 80% of an adhesive system comprising 40-60% urethane prepolymer and 40-60% polymeric methylene diphenyl diisocyanate, 18% acetone, 2% fullerene, and 1% chemical surfactant.

Another exemplary thermally conductive coating composition comprises a urethane prepolymer, a polymeric methylene diphenyl diisocyanate, carbon nanotubes, and at least one organic solvent selected from the group consisting of: xylene, acetone, benzene, D-limonene and toluene. This exemplary thermal conductive coating composition having a number of alternative compositions. One alternative composition comprising 80% of an adhesive system comprising 40-60% urethane prepolymer and 40-60% polymeric methylene diphenyl diisocyanate; 9% xylene; 8% acetone; 2% fullerene; and 1% chemical surfactant. Another alternative composition comprising 80% of an adhesive system comprising 40-60% urethane prepolymer and 40-60% polymeric methylene diphenyl diisocyanate, 9% xylene, 8% acetone, 2% fullerene, and 1% chemical surfactant. Another alternative composition comprising 75% of an adhesive system comprising 40-60% urethane prepolymer and 40-60% polymeric methylene diphenyl diisocyanate, 12.5% D-limonene, 9.5-10.5% acetone, and 0.75-2% fullerene.

Another alternative composition comprising 75% of an adhesive system comprising 40-60% urethane prepolymer and 40-60% polymeric methylene diphenyl diisocyanate, 12.5% D-limonene, 9.5-10.5% acetone, 0.75-2% fullerene, and about 0-2.5% pigment. Another alternative composition comprising 80% of an adhesive system comprising 40-60% urethane prepolymer and 40-60% polymeric methylene diphenyl diisocyanate, 18% acetone, 2% fullerene, and 1% chemical surfactant.

Another exemplary thermally conductive coating composition comprises 75%-85% of an urethane comprising 40-60% urethane prepolymer and 40-60% polymeric methylene diphenyl diisocyanate; 20-40% of at least one thinning agent, wherein the at least one thinning agent comprises an organic solvent; 0-3.75% nanoparticles, wherein the nanoparticles comprise carbon nanotubes and metal nanospheres; and 0-2% of at least one chemical surfactant.

Exemplary methods of making a thermally conductive coating compositions are also described. An exemplary method comprises the steps of: thinning an adhesive system comprising 40-60% urethane prepolymer and 40-60% polymeric methylene diphenyl diisocyanate with an organic solvent thinning agent; mixing the mixture mechanically; adding nanoparticles to the mixture; mixing the mixture mechanically; homogenizing the mixture via an ultrasonic homogenizer; and storing the mixture in an air-tight container.

Additional understanding of the devices and methods contemplated and/or claimed by the inventor(s) can be gained by reviewing the detailed description of exemplary devices and methods, presented below, and the referenced drawings.

### BRIEF DESCRIPTION OF THE DRAWINGS

FIG. 1 is a cross-sectional view of the nanocomposite coating layer of a first exemplary composition formulation.

FIG. 2 is a visual representation of thermal hotspots in the nanocomposite coating layer of the first exemplary composition formulation coating illustrated in FIG. 1.

### DETAILED DESCRIPTION

The following description and the referenced drawings provide illustrative examples of that which the inventor regards as their invention. As such, the embodiments discussed herein are merely exemplary in nature and are not intended to limit the scope of the invention, or its protection, in any manner. Rather, the description and illustration of these embodiments serve to enable a person of ordinary skill in the relevant art to practice the invention.

The use of “e.g.,” “etc,” “for instance,” “in example,” and “or” and grammatically related terms indicates non-exclusive alternatives without limitation, unless the context clearly dictates otherwise.

The use of “including” and grammatically related terms means “including, but not limited to,” unless the context clearly dictates otherwise.

The use of the articles “a,” “an” and “the” are meant to be interpreted as referring to the singular as well as the plural, unless the context clearly dictates otherwise. Thus, for example, reference to “a thinning agent” includes two or more such thinning agents, and the like.

The use of “optional” and grammatically related terms means that the subsequently described element, event or circumstance may or may not be present/occur, and that the description includes instances where said element, event or circumstance occurs and instances where it does not, unless the context clearly dictates otherwise.

The use of “preferred” and grammatically related terms means that a specified element or technique is more acceptable than another, but not that such specified element or technique is a necessity, unless the context clearly dictates otherwise.

The use of “exemplary” means “an example of” and is not intended to convey a meaning of an ideal or preferred embodiment.

The use of “substrate” means “a material having a surface,” unless the context clearly dictates otherwise. Exemplary substrates comprise corrodible surfaces utilized to transmit heat, including but not limited to condensing coils on window air conditioners, refrigerators, chillers, heaters, radiators, HVAC systems, etc. Typically, substrates are comprised of a conductive material such as copper, copper alloys, aluminum, and aluminum alloys. Frequently, substrates are located in outdoor, marine and industrial conditions, including corrosive environments subject to salty and/or acidic agents, and frequently can see temperature fluctuations exceeding 150° F. (65.6° C.) annually.

The use of “urethane” means “a moisture curing, 100% solids polyurethane adhesive system comprising urethane prepolymer (preferably 40-60% weight percent) and polymeric MDI (methylene diphenyl diisocyanate) (preferably 40-60% weight percent),” unless the context clearly dictates otherwise. The preferred urethane comprising IPS 02107 adhesive, or another urethane/polymer blend. The polymeric MDI preferably 4,4-MDI. The urethane may be surfactant treated. Exemplary formulations can comprise 40-95% aliphatic urethane, preferably 75-85%, and more preferably 80%. Other polymers and polymer blends could be utilized in the place of the “urethane.”

The use of “nanoparticle” means “a microscopic particle having at least one dimension of 100 nanometers (nm) or less,” unless the context clearly dictates otherwise. Nanoparticle shapes include, but are not limited to, nanospheres, nanotubes (buckytube), megatubes, nano-onions, buckyballs and buckyball clusters, and fullerene rings. Examples of nanoparticles include, but are not limited to, fullerenes (e.g., carbon nanotubes, Buckminsterfullerene), and metal nanospheres. The nanoparticles provide thermal reservoirs within the composition, allowing a higher specific heat (meaning that the nanocomposite is more resistant to temperature change, allowing temperature differentials to remain constant). Exemplary formulations can comprise 0-3.75% nanoparticles, preferably 0-1.75%, more preferably 1.60%.

The use of “fullerene” means “any molecule composed entirely of carbon, in the form of a hollow sphere, ellipsoid or tube, including but not limited to carbon nanotubes” unless the context clearly dictates otherwise.

The use of “carbon nanotube” means “an allotrope of carbon with a cylindrical nanostructure,” unless the context clearly dictates otherwise. Carbon nanotubes are excellent thermal conductors along their long axis, and are typically poor conductors through their diameters. Randomly dispersed carbon nanotubes provide photon “shortcuts”, allowing thermal energy to transverse the composition hundreds of times better than as through a polymer alone. Additionally, the carbon nanotubes will pierce the cell membrane of any bacteria or fungi that begins to eat away at the polymer, and thereby kill said microorganism. In exemplary composition formulations, such carbon nanotubes comprise a powder. In exemplary compositions, the carbon nanotubes comprises powdered, industrial grade, multi-walled carbon nanotubes of diameter 5.0 nanometers (nm) to 50.0 nm, and a length of 10.0 micrometer (μm) to 250.0 μm. In other exemplary compositions, single-walled carbon nanotubes could be utilized, as could modified grapheme, or other fullerenes.

The use of “metal nanosphere” means a spherical nanoparticle formed of metal particles and/or metal oxide particles. Exemplary metals include, but are not limited to, gold, silver, iron, platinum and copper. Exemplary metal-oxides include, but are not limited to, copper oxide, zinc oxide, and titanium oxide. Metal nanospheres have good thermal conductivity values which are valid omnidirectionally. Some metal nanospheres (e.g., copper nanospheres, copper-oxide nanospheres) show anti-microbial qualities. In exemplary compositions, the metal nanospheres comprise aluminum nanospheres (1-8% by weight, preferably 0.25% (+/−0.05%)), or zinc oxide nanospheres (1-4% by weight, preferably 1.25% (+/−0.05%)), or titanium oxide nanospheres (1-4% by weight (preferably 2.0% (+/−0.05%)).

The inventive concepts disclosed herein are thermally conductive nanocomposite coating compositions comprising urethane with embedded nanoparticles. The nanocomposite composition providing an elastomeric coating which is resistant to corrosion, water, oxygen, acids and salts, and which enhances cooling performance and thermal conductivity, particularly for heat exchange equipment. Particular exemplary nanocomposite compositions further providing an antimicrobial coating for inhibiting the growth of mold, mildew, bacteria and fungus on a treated surface.

Exemplary composition formulations comprising urethane, at least one thinning agent, and nanoparticles. Exemplary composition formulations may also comprise an additive in addition to, or as a substitute for the nanoparticles. The exemplary composition formulations allowing for environmental protection of a substrate while retaining a maximum magnitude of thermal conductivity. The exemplary nanocomposite coating compositions can be utilized as an anti-corrosion coating (environmental protection) that exhibits moderately high thermal conductivity qualities, moderately high thermal diffusivity qualities, moderately high specific heat values, and inherent anti-microbial/anti-fouling characteristics.

The thinning agent(s) comprising an organic solvent. Examples of suitable organic solvents include, but are not limited to, benzene-based solvents, terpene-based solvents, 1,4 xylene, tolulene, acetone, D-limonene (e.g., orange terpene), isocyanate-reactive monoterpenes, and other terpenes. The thinning agent can be used to thin the urethane, and/or to dilute the nanoparticles. Acetone works well where the application does not require slower evaporation. When the nanoparticles are fullerenes, toluene is the preferred thinning agent. Exemplary formulations can comprise 5-60% of one or more thinning agents, preferably 20-40%, more preferably 21%. One exemplary thinning agent composition comprises a 40:60 mixture of toluene and orange terpene.

The thinning agent(s) for: (1) diluting and partially suspending the nanoparticles, (2) thinning the urethane and thereby adjusting the viscosity of the composition, for instance thinning the urethane to the point that the mixture has a viscosity below 2 centipoises, so that it can be applied to metal surfaces (substrate) through spraying, dipping, flooding or other techniques.

Table I provides preferred ranges for some exemplary thinning agents.

TABLE I

| | Range |
|---|---|
| D-limonene | 0%-50% |
| Toluene | 0%-25% |
| Xylene | 0%-25% |
| Acetone | 0%-25% |

The additive comprising a powdered or liquefied pigment, and/or a chemical surfactant. Examples of pigments include, but are not limited to, bone black, titanium dioxide, dyes for color matching, etc. Examples of chemical surfactants include, but are not limited to those produced by BYK-Gardner under the brand names DISPERBYK®-2155, DISPERBYK®-9077, DISPERBYK®-378 and DISPERBYK®-333. Exemplary formulations can comprise 0-5% additive, preferably 1-2%, more preferably 1%.

In exemplary nanocomposite compositions where the nanoparticles comprise carbon nanotubes: (1) the urethane provides adhesion to the surface of the substrate, while protecting the substrate's surface from contact with reactive chemicals (e.g., chlorides, oxygen), and thereby preventing corrosion; (2) the carbon nanotubes greatly enhance the thermal conductivity through the coating, providing thermal “short-cuts” through which heat energy is quickly transmitted through the protective urethane, and further, the carbon nanotubes behave as a surfactant, limiting the foaming behaviors of the urethane during the mixing process; and (3) the thinning agent(s) aid in the workability of the nanocomposite composition, and ideally evaporate away prior to the nanocomposite composition's curing after being applied to the substrate. Further, (1) the urethane is inert and provides a hermetic seal over the substrate's surface, (2) the urethane encapsulates carbon nanotubes which have been randomly oriented within the nanocomposite composition, (3) the carbon nanotubes (which are preferably thousands of times longer than their diameter) are far more thermally conductive than the base urethane coating and thereby enhance heat transfer by swiftly moving heat energy from hot areas to cooler areas, and (4) the thinning agent(s) provide temporary workability to the composition, until the composition cures, and evaporate away without causing stress to the finished nanocomposite composition coating layer.

The compositions are preferably made in an enclosed system, with humidity as near to zero as possible. Temperature during processing should be as low as practicable, preferably at room temperature. The urethane is heat and humidity cured, so moisture contamination is also unacceptable. If the curing environment is high-humidity, the substrate metal and the coating must be kept above ambient temperature so that moisture does not condense on the coating (which creates a dull look that is aesthetically unpleasing but which does not detrimentally affect coating performance). It is preferred that the composition not be exposed to water, acid, or alkaline contaminations before it has fully cured (approximately twenty-four hours at 60° F. (15.6° C.), 50% humidity). The cured nanocomposite composition should not be continuously exposed to solvents (e.g., acetone, xylene, or any methyl-group chemicals), nor should it be exposed to excessive heat.

In a first exemplary method of making an exemplary composition, the urethane is thinned with a thinning agent and is mixed mechanically to ensure an even consistency. While the mixture is being mechanically mixed, the nanoparticles are incorporated into the mixture, the mixing continuing until all of the nanoparticles have been incorporated, taking care not to allow excess heat or humidity into the mixture. The mixture is then homogenized using an ultrasonic homogenizer to disperse and distribute the constituent nanoparticles into a uniformly randomly-oriented lattice network encapsulated by the urethane. The mixture is then stored in an air-tight container void of humidity.

In a second exemplary method of making an exemplary composition, the urethane is thinned with D-limonene and toluene, and mixed mechanically to ensure an even consistency. While the mixture is being mechanically mixed, fullerene particles are introduced into the mixture by blowing them into the mixing vortex using a stream of dehumidified air. The mechanical mixing continues until the fullerene has been incorporated, taking care not to allow excess heat or humidity into the mixture. Using at least two (2), paired, solvent-suitable pumps, the mixture is simultaneously metered through an inline, ultrasonic flow cell powered by an ultrasonic homogenizer which disperses and distributes the constituent nanoparticles into a uniformly randomly-oriented lattice network encapsulated by the base material. Once the initial sonfier cycle has completed, the mixture is continuously cycled through the homogenizer, preferably back and forth between the storage reservoir and the flow cell, until the mixture has received approximately 50 kJ of energy per gallon of uncured product (minimum 40 kJ, maximum increases if processing time is slowed and drawn out). The mixture is then stored in an air-tight container void of humidity.

In a third exemplary method of making an exemplary composition, the urethane is thinned with D-limonene and toluene, and mixed mechanically to ensure an even consistency. While the mixture is being mechanically mixed, fullerene particles are introduced into the mixture by blowing them into the mixing vortex using a stream of dehumidified air. The mechanical mixing continues until the fullerene has been incorporated, taking care not to allow excess heat or humidity into the mixture. Using a solvent-suitable pump, the mixture is metered through an inline, ultrasonic flow cell powered by an ultrasonic homogenizer which disperses and distributes the constituent nanoparticles into a uniformly randomly-oriented lattice network encapsulated by the base material. Once the initial sonfier cycle has completed, the mixture is continuously cycled through the homogenizer, preferably back and forth between the storage reservoir and the flow cell, until the mixture has received approximately 50 kJ of energy per gallon of uncured product (minimum 40 kJ, maximum increases if processing time is slowed and drawn out). The mixture is then stored in an air-tight container void of humidity.

In a fourth exemplary method of making an exemplary composition, the fullerenes are immersed into toluene, thereby ensuring complete wetting and event dispersion of the fullerenes. The urethane is thinned with D-limonene, and mixed mechanically to ensure an even consistency. While the urethane/D-limonene mixture is being mechanically mixed, the toluene/fullerene admixture is introduced into the urethane/D-limonene mixture. The mechanical mixing continues until the mixture and admixture are incorporated together, taking care not to allow excess heat or humidity into the mixture. Using at least two (2), paired, solvent-suitable pumps, the mixture is simultaneously metered through an inline, ultrasonic flow cell powered by an ultrasonic homogenizer which disperses and distributes the constituent nanoparticles into a uniformly randomly-oriented lattice network encapsulated by the base material. Once the initial sonfier cycle has completed, the mixture is continuously cycled through the homogenizer, preferably back and forth between the storage reservoir and the flow cell, until the mixture has received approximately 50 kJ of energy per gallon of uncured product (minimum 40 kJ, maximum increases if processing time is slowed and drawn out). The mixture is then stored in an air-tight container void of humidity.

In a fifth exemplary method of making an exemplary composition, the fullerenes are immersed into toluene, thereby ensuring complete wetting and event dispersion of the fullerenes. The urethane is thinned with D-limonene, and mixed mechanically to ensure an even consistency. While the urethane/D-limonene mixture is being mechanically mixed, the toluene/fullerene admixture is introduced into the urethane/D-limonene mixture. The mechanical mixing continues until the mixture and admixture are incorporated together, taking care not to allow excess heat or humidity into the mixture. Using a solvent-suitable pump, the mixture is metered through an inline, ultrasonic flow cell powered by an ultrasonic homogenizer which disperses and distributes the constituent nanoparticles into a uniformly randomly-oriented lattice network encapsulated by the base material. Once the initial sonfier cycle has completed, the mixture is continuously cycled through the homogenizer, preferably back and forth between the storage reservoir and the flow cell, until the mixture has received approximately 50 kJ of energy per gallon of uncured product (minimum 40 kJ, maximum increases if processing time is slowed and drawn out). The mixture is then stored in an air-tight container void of humidity.

In a sixth exemplary method of making an exemplary composition, the urethane is thinned with D-limonene, and mixed mechanically to ensure an even consistency. While the urethane/D-limonene mixture is being mechanically mixed, using toluene, the fullerenes are immersed into solution while mixing to ensure complete wetting and even dispersion. The mechanical mixing continues until the mixture is incorporated, taking care not to allow excess heat or humidity into the mixture. Using at least two (2), paired, solvent-suitable pumps, the mixture is simultaneously metered through an inline, ultrasonic flow cell powered by an ultrasonic homogenizer which disperses and distributes the constituent nanoparticles into a uniformly randomly-oriented lattice network encapsulated by the base material. Once the initial sonfier cycle has completed, the mixture is continuously cycled through the homogenizer, preferably back and forth between the storage reservoir and the flow cell, until the mixture has received approximately 50 kJ of energy per gallon of uncured product (minimum 40 kJ, maximum increases if processing time is slowed and drawn out). The mixture is then stored in an air-tight container void of humidity.

In a seventh exemplary method of making an exemplary composition, the urethane is thinned with D-limonene, and mixed mechanically to ensure an even consistency. While the urethane/D-limonene mixture is being mechanically mixed, using toluene, the fullerenes are immersed into solution while mixing to ensure complete wetting and even dispersion. The mechanical mixing continues until the mixture is incorporated, taking care not to allow excess heat or humidity into the mixture. Using a solvent-suitable pump, the mixture is metered through an inline, ultrasonic flow cell powered by an ultrasonic homogenizer which disperses and distributes the constituent nanoparticles into a uniformly randomly-oriented lattice network encapsulated by the base material. Once the initial sonfier cycle has completed, the mixture is continuously cycled through the homogenizer, preferably back and forth between the storage reservoir and the flow cell, until the mixture has received approximately 50 kJ of energy per gallon of uncured product (minimum 40 kJ, maximum increases if processing time is slowed and drawn out). The mixture is then stored in an air-tight container void of humidity.

The preferred ultrasonic homogenizer comprising a 250 W (minimum 125 W), medical-grade sonifier, producing a minimum of 90 dB of ultrasonic sound waves.

A first exemplary composition formulation comprising 85% urethane, 5% D-limonene, 5% toluene, 2% fullerene, and 1% chemical surfactant.

A second exemplary composition formulation comprising 80% urethane, 9% xylene, 8% acetone, 2% fullerene, and 1% chemical surfactant.

A third exemplary composition formulation comprising 80% urethane, 17% D-limonene, 2% fullerene, and 1% chemical surfactant.

A fourth exemplary composition formulation comprising 75% urethane, 12.5% D-limonene, 9.25% acetone, 0.75% fullerene, and 2.5% pigment.

A fifth exemplary composition formulation comprising 78% urethane, 15% xylene, 3.5% acetone, and 3.5% pigment.

A sixth exemplary composition formulation comprising: 94.25% urethane, 3.75% industrial grade multi-walled carbon nanotubes, 0.25% aluminum nanospheres, 1.25% zinc oxide nanospheres, 2.0% titanium oxide nanospheres, or in any combination, with surfactants and or solvents added to reach a target consistency or viscosity.

A seventh exemplary composition formulation comprising 80% urethane, 17% of at least one thinning agent, 2% nanoparticles, and 1% chemical surfactant.

An eighth exemplary composition formulation comprising 75% urethane, 21.5% of at least one thinning agent, and 3.5% pigment.

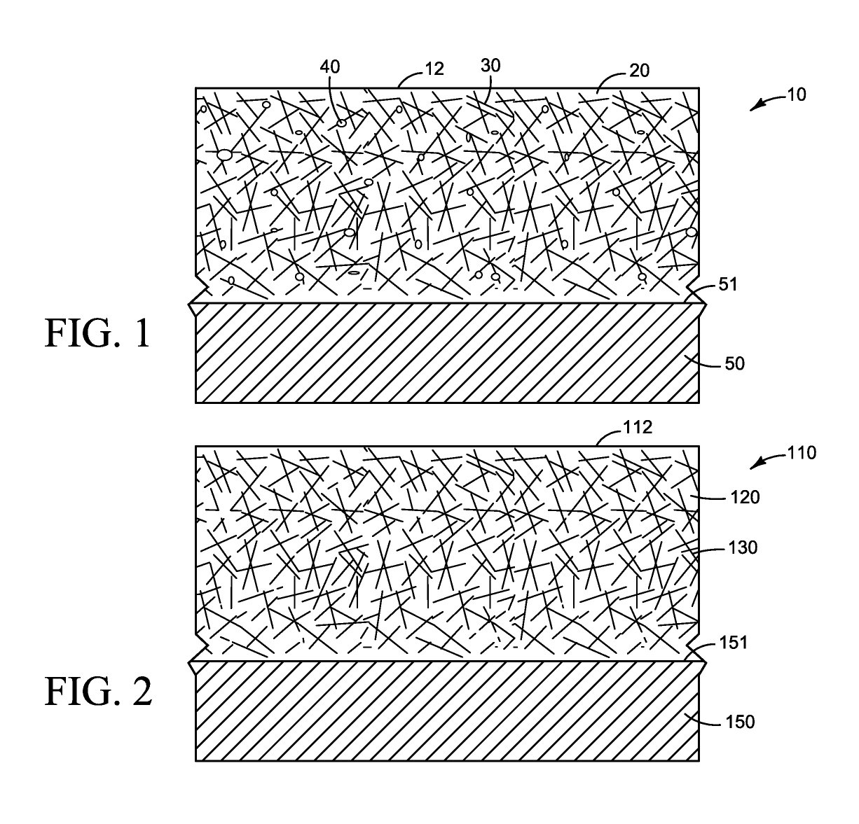

Referring initially to FIG. 1, illustrated is a cross-sectional view of the nanocomposite coating layer of an exemplary composition formulation. Illustrated is a nanocomposite coating 10 applied to a substrate 50 at a surface 51 of the substrate 50. The nanocomposite coating 10 comprising a urethane base component 20 having fullerenes 30 and metal nanospheres dispersed therein.

Referring to FIG. 2, illustrated is a cross-sectional view of the nanocomposite coating layer of another exemplary composition formulation. Illustrated is a nanocomposite coating 110 applied to a substrate 150 at a surface 151 of the substrate 150. The nanocomposite coating 110 comprising a urethane base component 120 having fullerenes 130 dispersed therein.

Any application process (e.g., spraying, dipping, flooding) can be utilized to apply the nanocomposite coating composition to the surface of a substrate, and a skilled artisan will be able to select an appropriate application process and equipment for the exemplary composition in a particular embodiment based on various considerations, including the intended use of the exemplary composition, the intended arena within which the exemplary composition will be used, the environmental conditions, the type of the substrate, the location of the substrate, and the equipment and/or accessories with which the exemplary composition is intended to be used, among other considerations. It is preferred that the nanocomposite coating composition be applied in any thickness. Specifically, applying the nanocomposite coating composition 05.-4.0 mil (one-thousandths of an inch) (12.70-101.60 μm) thick to the surface of the substrate, and more specifically 1.0 mil (25.40 μm) thick to the surface of the substrate.

One exemplary method of making a thermally conductive coating composition comprising the steps of: thinning an adhesive system comprising 40-60% urethane prepolymer and 40-60% polymeric methylene diphenyl diisocyanate with an organic solvent thinning agent; mixing said mixture mechanically; adding nanoparticles to said mixture; mixing said mixture mechanically; homogenizing said mixture via an ultrasonic homogenizer; and storing said mixture in an air-tight container.

Any suitable structure and material and/or chemical compound can be used in the exemplary compositions, and a skilled artisan will be able to select an appropriate structure and material for the exemplary composition in a particular embodiment based on various considerations, including the intended use of the exemplary composition, the intended arena within which the exemplary composition will be used, and the equipment and/or accessories with which the exemplary composition is intended to be used, among other considerations.

It is noted that all structures, features and components of the various described and illustrated embodiments can be combined in any suitable configuration for inclusion in an exemplary composition according to a particular embodiment.

The foregoing detailed description provides exemplary embodiments of the invention and includes the best mode for practicing the invention. The description and illustration of these embodiments is intended only to provide examples of the invention, and not to limit the scope of the invention, or its protection, in any manner.

1. A thermally conductive coating composition comprising: a urethane prepolymer; a polymeric methylene diphenyl diisocyanate; at least one thinning agent; and nanoparticles.

2. The thermally conductive coating composition of claim 1, wherein said nanoparticles comprise fullerenes.

3. The thermally conductive coating composition of claim 1, wherein said nanoparticles comprise carbon nanotubes.

4. (canceled)

5. The thermally conductive coating composition of claim 1, wherein said thinning agent comprises at least one organic solvent.

6. The thermally conductive coating composition of claim 5, wherein said organic solvent is selected from the group consisting of xylene, acetone, D-limonene, and toluene.

7. The thermally conductive coating composition of claim 1, further comprising an additive selected from the group consisting of at least one pigment and at least one chemical surfactant.

8-16. (canceled)

17. A thermally conductive coating composition comprising: a urethane prepolymer; a polymeric methylene diphenyl diisocyanate; at least one organic solvent selected from the group consisting of: xylene, acetone, benzene, D-limonene and toluene; and carbon nanotubes.

18-23. (canceled)

24. The thermally conductive coating composition of claim 2, wherein said thinning agent comprises at least one organic solvent.

25. The thermally conductive coating composition of claim 24, further comprising an additive selected from the group consisting of at least one pigment and at least one chemical surfactant.

26. The thermally conductive coating composition of claim 25, wherein said organic solvent is selected from the group consisting of xylene, acetone, D-limonene, and toluene.

27. The thermally conductive coating composition of claim 26, further comprising an additive selected from the group consisting of at least one pigment and at least one chemical surfactant.

28. The thermally conductive coating composition of claim 3, wherein said thinning agent comprises at least one organic solvent.

29. The thermally conductive coating composition of claim 28, further comprising an additive selected from the group consisting of at least one pigment and at least one chemical surfactant.

30. The thermally conductive coating composition of claim 29, wherein said organic solvent is selected from the group consisting of xylene, acetone, D-limonene, and toluene.

31. The thermally conductive coating composition of claim 30, further comprising an additive selected from the group consisting of at least one pigment and at least one chemical surfactant.

32. The thermally conductive coating composition of claim 2, further comprising an additive selected from the group consisting of at least one pigment and at least one chemical surfactant, and wherein said organic solvent is selected from the group consisting of xylene, acetone, D-limonene, and toluene.

33. The thermally conductive coating composition of claim 3, further comprising an additive selected from the group consisting of at least one pigment and at least one chemical surfactant, and wherein said organic solvent is selected from the group consisting of xylene, acetone, D-limonene, and toluene.
